(19) United States
(12) Patent Application Publication
(10) Pub. No.: US 2010/0278692 A1
(43) Pub. Date: Nov. 4, 2010

(54) NOVEL DRUG CHECKING CUP FOR IN FIELD DRUG TESTING

(76) Inventor: Jainfeng Chen, Hayward, CA (US)

Correspondence Address: JOSEPH L. STRABALA, ESQ., ONE EMBARCADERO CENTER, SUITE 1020, SAN FRANCISCO, CA, 94111, US

(21) Appl. No.: 12/432,008

(22) Filed: Apr. 29, 2009

(51) Int. Cl. G01N 21/01

(52) U.S. Cl. 422/58

(57) ABSTRACT

A drug checking cup includes a special container constructed of a transparent plastic with an oval truncated top member and an oval truncated bottom member connected by a continuous wall to form a container for the cup, with the continuous wall having a flat portion, plus a circular mouth formed in the top member and a lid operable to close the mouth along with a flat cassette containing at least one drug testing strip placed in the cup through the mouth and retainer means in the cup securing the cassette in the cup at an angle to the inner surface of said flat portion of the continuous wall and in close proximity thereto whereby images on the testing strip in the cassette can be viewed, photocopied and scanned through said flat portion of the wall without distortion from the presence of the specimen in the cup in the space between the cassette and the flat portion of the continuous wall.

Companies often require new employees to undergo pre-employment drug testing before hiring. Also, post-accident drug testing is routine, especially when flammable or hazardous materials are involved, or where the safety of a large number of people might be affected (e.g., accidents involving an oil tanker captain, a truck driver or an engineer of a train). Typically, a urine specimen is taken at the scene in these situations which is then checked for the existence of drugs.

Often tests are performed on site with commercially available drug checking devices. Drug checking cups for in situ or in field checking for drugs of abuse is one type of such device. For example, see U.S. Pat. No. 5,403,551 entitled “Assaying Device and Container for In Field Analysis of a Specimen and Later Shipment of the Unadulterated Specimen, issued to Galloway and U.S. Pat. Nos. 6,805,838; 6,805,837; and 6,497,843 issued to Tidings, entitled Assaying Device and Method for In-Field Urinalysis. Other patents for such devices included U.S. Pat. No. 6,726,879 issued to Ng et al. See also U.S. Pat. No. 6,140,136 issued to Lee.

Typically, the method of use of such drug checking cups is the deposit of a doner's body fluids (often referred to as a specimen), such as urine, in the cup, and then closing the cup with a lid. Within these cups are one or more than one test strips (a plurality), each of which strips is specific to a drug of abuse (or metabolites thereof) for which a test is desired. If such a drug of abuse or a metabolite thereof, is present in the body fluid in the cup, and a strip is wetted by such fluid, it will provide a visual indication of the presence of its designated drug of abuse which indication on the strip can be seen through the translucent/transparent wall of these cups.

Along with drug checking cups, the prior art teaches the use of drug test cassettes. In earlier test devices of this type the test strips were placed in a horizontal test bed and a technician placed a few drops of a specimen of a body fluid to be tested onto the sample area of the individual test strips. Typically a pipette is used to transfer the specimen from a collection container to the individual test strips. This is laborious procedure and, a process often subject to error, due to the human interaction involved. Subsequently the test strips were packaged in flat containers with the active ends of the test strips exposed in a manner so the packages could be dipped into a bulk fluid specimen to expose the strips to a sample to check for drugs. Due to this dipping process during their use, these later cassettes are often referred to ‘dippers’. Like the cups described, these test cassettes or dippers have reagent test strips disposed therein which react in the presence of certain metabolites, in this case those of drugs of abuse, which are present in a specimen used to wet the strip.

Various devices have been patented, using such cassettes or dippers involving the step of submerging them in a liquid specimen; see for example U.S. Pat. No. 7,222,547 issued to Alley. In the Alley patent, a cassette or dipper is inserted into the bulk specimen through a slot in the lid and then removed to read the results. If there is a positive indication on the strips in the cassette, the lid with the slot is removed and replaced with a secure lid which will seal the cup so it can be sent to a lab for further testing without leakage. Devices of this type are disliked because it brings the tests in possible contact with the specimen. Other patents using such cassettes or dippers in cups are U.S. Pat. No. 6,915,919 issued to Casterlin and U.S. Pat. No. 7,244,392 issued to Konecke. These latter two patent are the most pertinent patents to the instant invention known to the applicant. Also there is the device illustrated on the web site www.drugcheck.com that has two flat faces formed in a cup. In addition a product marketed as the E-Z Split Cup has a flat face in a cup design, see at www.ezkeycup.com.

Having the results of a drug check displayed and viewable through a flat surface or flat panel makes it easy to copy or scan these results to create a permanent record without a human transcription of the test results by an individual.

There are a wide range of drug testing techniques available in the market using antibody based competitive screening assays or chromatographic procedures in conjugation with mass spectrometric analysis for further validation purposes in laboratories. Field testing, such as urinalysis, blood drug tests, saliva based tests, sweat based tests, hair drug tests so and so forth are popular. However of the group, urinalysis offers the benefits of being inexpensive and less intrusive than blood drug tests and has been employed successfully for testing a diverse array of compounds. The major drawback of a urine test is that the donor can secretly adulterate or substitute the samples.

While the instant invention is primarily a urine test device the construction of the cup is designed to make it difficult to compromise the results by making it nearly impossible to remove the test cassette from the cup.

In general the above referenced devices are adapted to bring a portion of a liquid specimen or body fluids, such as a urine sample which is collected from an individual [a donor], into contact with test strips containing reagents which are responsive to the presence of drugs, such as amphetamines, cocaine, morphine, PCP, THC and/or their metabolites. Typically such reagents include, but are not limited to, colloidal gold coated sheep polyclonal anti-amphetamine, mouse monoclonal anti-benzoyl ecgonine, polyclonal rabbit anti-morphine-3 glucuronide, mouse monoclonal anti-cannabinoid or mouse monoclonal anti-phencyclidine, appropriate drug or drug analog conjugates, and immobilized antisera. The reaction of the strips with a specimen creates a visual indication on the strip which can be either a positive or a negative indication.

It is an object to provide a drug checking cup which has improved features and reliability through the innovations of constructing it with a flat face or panel and orienting a sealed cassette with testing strips therein having a separate communication port for each strip to enable the specimen to wet the strip, with the orientation being in a manner that so its results are easy to view and copy without distortion from the specimen liquid or configuration of the cup itself.

It is also a object to provide a novel cup wherein different width cassettes can be employed without impairing the function of the cup.

Further it is an object to produce a more economical drug checking cup.

### SUMMARY OF THE INVENTION

An improved drug checking cup system operable to check body fluids for drugs by placing the fluids to be checked in the novel cup which cup includes a special container constructed of a transparent plastic with an oval truncated top member and an oval truncated bottom member connected by a continuous wall to form a container for the cup, with the continuous wall having a flat portion, plus a circular mouth formed in the top member and a lid operable to close the mouth along with a flat cassette inserted through the mouth containing at least one drug testing strip operable to react with such body fluids placed in the cup when a drug specific to the strip is present in such fluids and a retainer means securing the cassette in the cup at an angle to the inner surface of said flat portion of the continuous wall and in close proximity thereto whereby images on the testing strip in the cassette can be viewed, photocopied and scanned through said flat portion of the continuous wall of the cup with minimum distortion from the presence of the specimen between the cassette and inner surface of the flat portion.

### DESCRIPTION OF THE DRAWINGS

FIG. 1 is a perspective of the container of the novel cup which has its lid exploded there from;

FIG. 2 is an elevation of the cassette with grooves for seven test strips;

FIG. 3 is a perspective of a four strip cassette, with parts exploded, that is inserted into the novel drug checking cup to complete it;

FIG. 4 is an elevation of the back of the cassette illustrated in FIG. 3;

FIG. 5 is a cross section of the novel cup without the cassette or lid;

FIG. 6 is the cross section of the novel cup shown in FIG. 5 with the cassette position therein;

FIG. 7 is an exploded cross section of the novel cup showing the two components of the cup that are welded together to construct the basic cup;

FIG. 8 is also an exploded cross section of the novel cup showing the two components of the cup that are welded together to construct the cup, but illustrating an alternate construction; and

FIG. 9 is a cross section of the novel cup with the cassette installed.

### DESCRIPTION OF AN EMBODIMENT

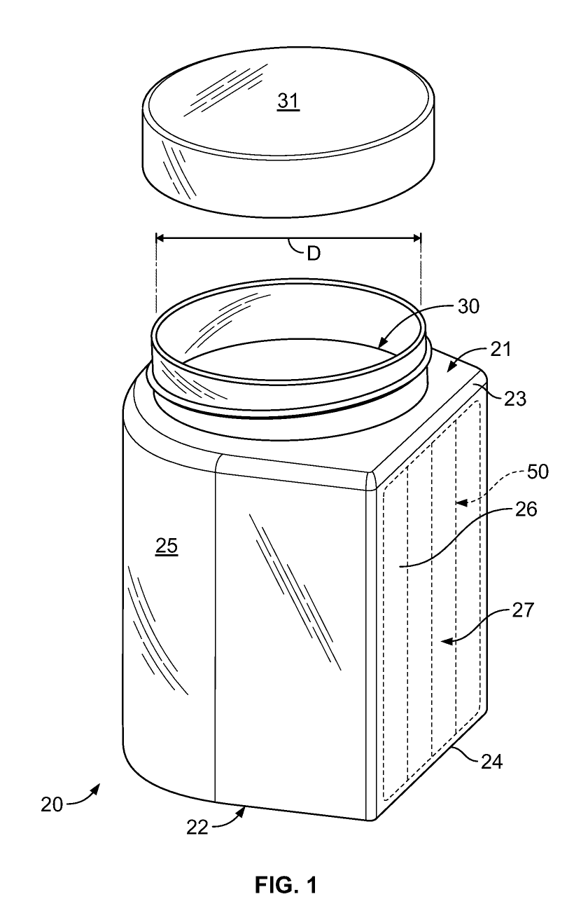

The novel cup 20 of this invention shown in FIG. 1 is typically injection molded of plastics, such as polyamideimide (PAI), polyethersulfone (PES), polyarylsulfone (PAS), polyetherimide (PEI), polyarylate (PAR), polysulfone (PSO), polyamide (PA), polycarbonate (PC), styrene-maleic anhydride (SMA), chlorinated PVC (CPVC), poly(methylmethacrylate) (PMMA), styrene-acrylonitrile (SAN), polystyrene (PS), acrylonitrile-butadiene-styrene (PS), acrylonitrile-butadiene-styrene (ABS), poly(ethyleneterephthalate) (PET), poly(vinylchloride) (PVC), polyetherketone (PEK), polyetheretherketone (PEEK), polytetrafluoroethylene (PTFE), poly(phenylene sulfide) (PPS), liquid crystal polymer (CCP), nylon-6,6, nylon-6, nylon-6,12, nylon-1, nylon 12, acetal resin, low and high density polypropylene (PP), high density polyethylene (HDPE), low density polyethylene (LDPE), polystyrene, ethylene-vinyl acetate, poly-vinyl-acetate, polyacrylic, etc., or a copolymer or a combination thereof. These and other plastics employed are transparent or translucent, so that items inside the cup can be viewed through the exterior wall of the cup.

More particularly, this novel cup 20 has an oval truncated top member 21 and a similar oval truncated bottom member 22. Truncated is meant to describe that the curving perimeters of these members is discontinuous at two locations and is replaced with a straight perimeter between the locations, forming a face 23 in the top member and a face 24 in the bottom member. The top and bottom members are connected by a curved continuous wall 25 which has a flat portion 26 that is connected to faces 23 and 24 to create a flat window 27 on the exterior of the cup remote from its mouth. The wall forms the body of the novel cup between the top member and the bottom member creating a container.

When using the described structure the flat window 27 can be placed on a photocopier platen and an image in the interior of the novel cup 20 can be conveniently viewed, copied or scanned without distortion like that which occurs with cylindrical drug checking cups, such as those disclosed in U.S. Pat. Nos. 5,403,551; 6,805,838; 6,805,837; and 6,497,843. In such round cups it is difficult obtain any useful image of the interior of the cup using a photocopier or scanner. Moreover the flat window disclosed in U.S. Pat. No. 7,244,392 likewise cannot be placed on a flat platen of a photocopy machine due to the design described therein, i.e., see the circular top and bottom parts of the cup.

Referring again to FIG. 1 the novel cup 20, includes a mouth 30 formed in the top member 21 which provides access to the interior of the cup. The mouth is closed by a lid 31 what is designed to form a fluid tight seal when assembled on the mouth. The seal can be accomplished by the use screw threads (shown on the cup) or the like to create such a fluid tight seal. The width D of the mouth is chosen to provide a maximum opening to the interior of the cup which facilitates the placing of body fluids in the cup and also allows the insertion into the cup of a cassette with multiple test strips disposed in its flat package.

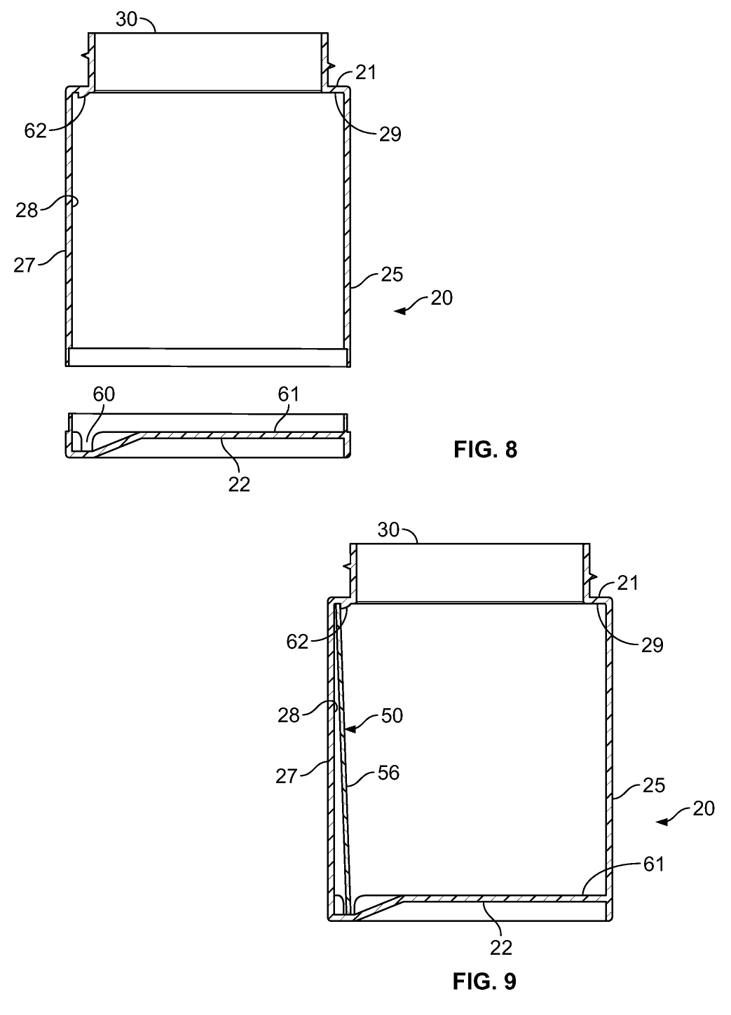

Construction of the cup 20 can be accomplished by injection molding it in two pieces and then welding the two parts together which enables the creation of its novel shape. For example, FIG. 7 shows an exploded cross section of cup, where the bottom member 22 and the continuous wall 25 are formed as a unit by injection molding. Like wise the top member 21 and the mouth 20 are formed as a separate unit by injection molding. Once these two parts are formed they are aligned and welded together to form the cup. FIG. 8 also shows an exploded cross section of the cup which includes two injected molded pieces. Instead of having the continuous wall 25 integral with the bottom member 22, this wall is formed with the top member 21 when it is molded. Thereafter the bottom member is welded to the bottom of the continuous wall to complete the cup.

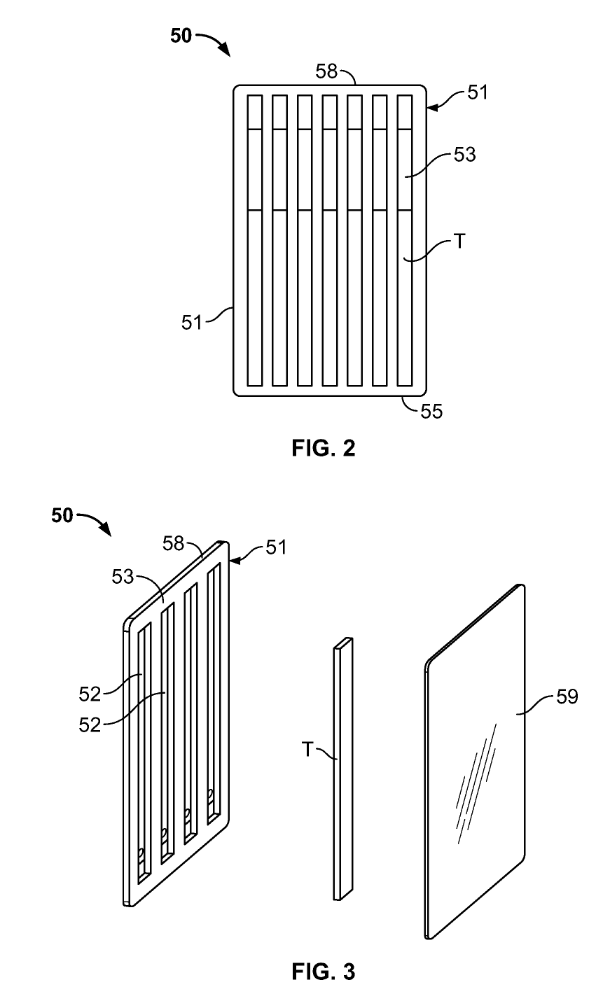

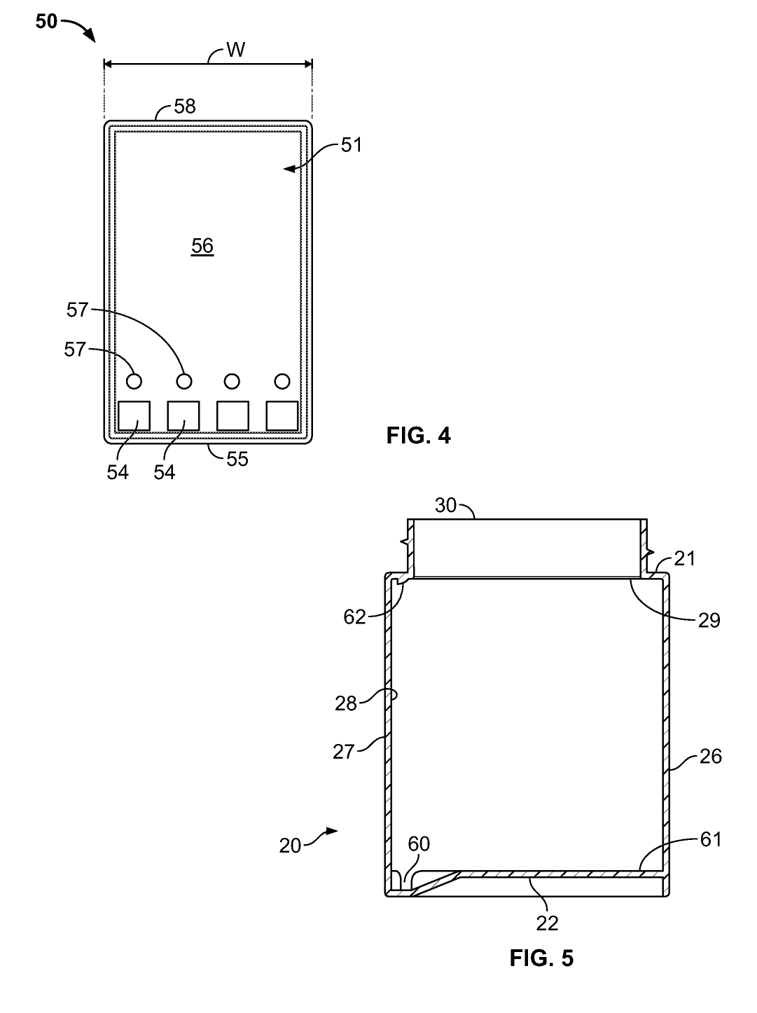

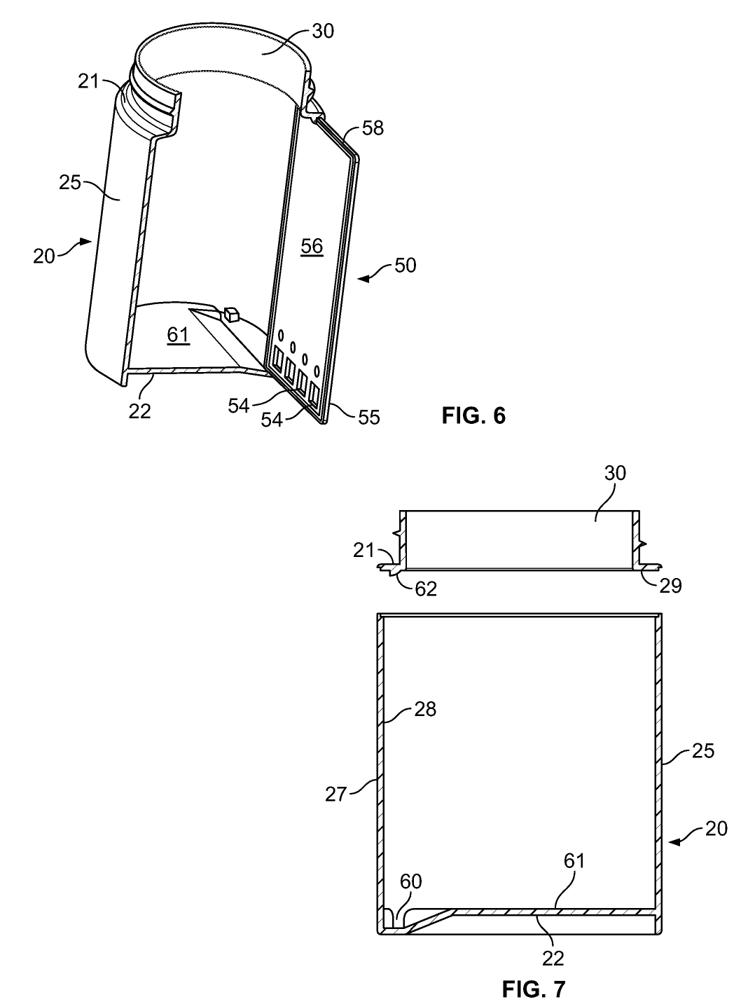

To complete the novel cup 20 a cassette or test card 50 is employed as shown in FIG. 2. This cassette or test card 50 includes a flat holder 51 which has a series of parallel slots 52 formed in its surface 53. The dimensions of the slots selected to closely approximate the width, length and thickness of the test strips to be employed in the cassette or test card. Such test strips can be purchased from Amedica Boitech, Inc. in Hayward, Calif. Further, as can be seen in FIG. 3, illustrating the back 56 of the cassette or card, there are individual windows 54 adjacent to the bottom end 55 of the cassette or card, with each window arranged to communicate with a separate one of the slots 52. In addition a port 57 is formed above each window which also communicates with the same slot as the window. When this cassette or card in placed in a bottom of a container, and a liquid specimen is added, the specimen enters the windows and any excess air bleeds out through the associated port above its window. This arrangement ensures maximum wetting of the portion of the test strip placed in the associated slot through the associated window when a test occurs.

After a series of test strips T are placed in the slots 52 a transparent cover 58 is attached to the surface 53 of the holder to isolate the individual strips from one another in the associated slot so that the only fluid communication with these test strips is through one of the windows 54. In the art it is conventional to use strips which are hermetically sealed in the slots in a cassette with the exception of the associated port to allow the ingress of part of a specimen. Isolation of the strips in this manner reduces the adulteration among the several strips though cross contamination.

The drawings illustrate windows 54 and ports 57 in the rear face or back 56 of the cassette or card 50, but it is also within the compass of the invention to employ window or ports on the front face of the cassette or card since the bottom 55 of the cassette or card is offset from the interior surface 28 of the flat window. Thus a window or port for a one of slots 52 may be on either face of the cassette or card with out departing from the spirit of the invention.

The width W of the cassette or card 50 is such that it will fit though mouth 30 of the cup 20. Once the cassette or card is inserted into the cup, it is moved so that its transparent cover is adjacent to the interior surface 28 of the flat window 27. As a result the test strips in the cassette or card can be viewed through the flat window and the indications on the test strips can be readily seen and recorded on a photocopier once a test has been concluded. However as can be seen in FIG. 9 the cassette is positioned in the cup so it does not abut against the interior surface 28 of the flat window or panel 27. This angular spacing allows the specimen to flow between the front of the cassette and the interior surface of the window eliminating fogging or streaking of the window which could obscure or distort view of the strips in the cassette. Further, this arrangement allows cassettes of lesser widths (having fewer test strips), to be employed in the cup since the design does not require any seal between the cassette and the interior surface of the flat window whereby the width of the cassette is not critical beyond the maximum determined by the diameter of the mouth 30.

The angular spacing of the cassette 50 in the cup 20 is accomplished by retention means adjacent to the interior surface 28. Such retention means are designed to lock the cassette or card 50 in place once it is moved into the location described so that it cannot be removed or tampered with by a donor providing a specimen to be tested. One of the preferred arrangements is an elongated well 60 shown in FIG. 9 in the bottom member 22 of the novel cup 20 that receives the bottom end 55 of the cassette or card 50 as can be seen in FIG. 9. This well also collects a portion of the specimen in the well ensuring there will be enough specimen in the location of windows 54 to wet the test strips in the cassette or card when only a minimum amount of specimen is available. In addition the floor 61 or the bottom member 22 can be inclined to direct the specimen into the well when the cup 20 is upright when a minimum amount of specimen is available.

On the underside 29 of the top member 21 are spaced cleats 62 extending downwardly into cup 20. Thus, as the cassette or card 50 has it bottom end 55 placed in the well 60 and its top end is pushed toward the interior surface 28 of the flat window 27, the top edge 58 of the cassette or card is forced under the cleats and after passing these cleats the card cannot be removed from its location adjacent to the flat window of the novel cup 20. This is an important feature, since if the cassette or card can be easily removed by a donor undergoing a test, the donor can merely replace the cassette or card with a different cassette or card to flummox the test. Moreover the location of the cassette after it is inserted is difficult to access through the mouth of the cup.

By locating the cassette or card 50 adjacent to the interior surface 28 of the flat window 27 the present of urine between the transparent cover 59 of the cassette and the inside surface of the window will also be minimized so recordation of the test results are not distorted by the presence of the thin layer of the doner's body fluids between the interior surface of the flat window and the cassette.

Having described my invention, I claim:

1. An improved drug checking cup system operable to check body fluids for drugs in the field by placing such fluids to be checked in the novel cup comprising:
a container means constructed of transparent plastic having an oval truncated top member and an oval truncated bottom member connected by a continuous wall to form a container for said cup, said continuous wall having a flat portion;
a circular mouth formed in said top member with a lid means operable to sealingly close said mouth;
a flat cassette means containing at least one drug testing strip means operable to react with such body fluids placed in said cup when a metabolite specific to said strip is present in such fluids; and
retention means angularly securing said cassette means in said cup adjacent to the inner surface of said flat portion of said continuous wall and in close proximity thereto whereby images in said cassette means can viewed and photocopied through said flat portion with minimum distortion.

2. The drug checking cup defined in claim 1 wherein the retention means includes an elongated well in the bottom of said cup off set from the flat portion of said cup operable to receive the bottom of the cassette means and the inside surface of the top member includes cleat means adjacent to said flat portion operable to secure the top of said cassette means whereby said cassette means is retained in the cup at an angle to said flat portion by said well and cleat means.

3. The drug checking cup defined in claim 1 wherein the cassette means includes a plurality of drug testing strips.

4. The drug checking cup defined in claim 1 wherein the cassette means includes at least one groove adapted to receive a test strip and a transparent cover operable to seal said test strip in such groove except for the window and port in communication with such groove.

5. The drug checking cup defined in claim 1 wherein the retention means includes an elongated channel in the bottom member of the cup located remote from the interior surface of the flat portion which is adapted to receive the bottom of the flat cassette means and downwardly directed cleats on the interior of the top member located adjacent to said flat portion operable to retain the top of said flat cassette means between said cleats and the said flat portion after said top portion passes under said cleats.
